(19) United States
(12) Patent Application Publication
(10) Pub. No.: US 2007/0295731 A1
(43) Pub. Date: Dec. 27, 2007

(54) Nickel-plated metal cookware

(76) Inventor: Michael T.P. Hanson, Monroe, NC (US)

Correspondence Address: RALPH H. DOUGHERTY, 6100 FAIRVIEW ROAD, SUITE 550, CHARLOTTE, NC, 28210, US

(21) Appl. No.: 11/899,146

(22) Filed: Sep. 4, 2007

Related U.S. Application Data
(63) Continuation-in-part of application No. 10/808,972, filed on Mar. 25, 2004.

(51) Int. Cl. A47J 27/00

(52) U.S. Cl. 220/573.1; 427/304

(57) ABSTRACT

Electroless-nickel-plated cast iron cookware, wherein a substrate consisting of a skillet, pot, pan or the like, is coated by cleaning and deoxidizing the surface of the cookware substrate, rinsing the substrate, soaking the substrate in a dilute potassium carbonate solution, and applying an electroless nickel coating to the surface of the metal substrate. The nickel-plated cast iron cookware product is also disclosed.

### CROSS REFERENCE TO RELATED APPLICATION

This application is a continuation-in-part of my co-pending U.S. patent application Ser. No. 10/808,972, filed on Mar. 25, 2004.

### FIELD OF THE INVENTION

The present invention relates generally to cast iron cookware, and more particularly to items of cookware having an electroless nickel outer layer, and to a method of plating cast iron cookware.

### BACKGROUND OF THE INVENTION

Cookware, particularly pans such as frying pans, pots, and the like are typically made of cast iron, steel, aluminum, copper, brass, or copper alloy.

Various coatings, treatment processes and metals have been used to improve the wearability and durability of cookware. However, after a period of use, the coatings tend to wear off or become eroded during the scrubbing and cleaning process or become corroded. Consumers typically have no means for avoiding such wear. As a result, worn or corroded cookwear is not used or it is discarded.

Cast iron, which is used for frying pans, is porous to a small degree. It retains minute particles from a previous item which was cooked in it. Thus, when cast iron is used for frying fish, then cleaned and used to make gravy, the gravy may develop a fish taste, which is objectionable. This is a particular problem in restaurants, because a frying pan can be used for different entrees or side dishes successively, which can affect the taste of the later cooked item.

Thus, there is a need for cookwear that provides an extended period of use without becoming corroded, and that does not lose metallic particles or oxides to the food being prepared. There is also a need for a non-stick pan that has the ability to cause food not to stick to the cooking surface during the entire lifetime of the pan.

### DESCRIPTION OF THE PRIOR ART

Applicant is aware of the following U.S. patents concerning electroless nickel coating of a substrate:

| U.S. Pat. No. | Issue Date | Inventor | Title |
|---|---|---|---|
| 2,532,283 | Dec. 5, 1950 | Brenner et al. | NICKEL PLATING BY CHEMICAL |
| | | | REDUCTION |
| 2,685,839 | Nov. 10, 1953 | Talmey et al. | PROCESS OF CHEMICAL NICKEL |
| | | | PLATING |
| 2,999,770 | Sep. 12, 1961 | Gutzeit | PROCESSES OF CHEMICAL NICKEL |
| | | | PLATING AND BATHS THEREFOR |
| 4,321,285 | Mar. 23, 1982 | Feldstein | ELECTROLESS PLATING |
| 5,753,313 | May 19, 1998 | Tsai | METHOD FOR COATING METAL |
| | | | COOKWARE |
| 6,309,583 | Oct. 30, 2001 | Feldstein | COMPOSITE COATINGS FOR |
| | | | THERMAL PROPERTIES |
| 6,605,368 | Aug. 12, 2003 | Smith | COOKWARE VESSEL |
| US Published Application | Aug. 7, 2003 | Tsai | ANTI-STICK COOKWARE WITH |
| 2003/0148033 | | | COOKWARE BODY FORMED BY |
| | | | SPINNING |

### SUMMARY OF THE INVENTION

The invention provides an electroless-nickel-plated surface on cast iron cookware, particularly on skillets and pots and pans. A substrate consisting of a skillet, griddle, pot, pan, grill or cooking grate (which terms are used interchangeably herein) to be coated is treated by cleaning and deoxidizing the surface of the substrate, rinsing the substrate, soaking the substrate in a dilute solution of potassium carbonate, and applying an electroless nickel plating or coating to the surface of the metal substrate.

### OBJECTS OF THE INVENTION

The principal object of the present invention is to provide a nickel plated cast iron skillet, pot, pan, grill, griddle, or other metal cookware.

Another object of the invention is to provide a cast iron cookware item having a plating that inhibits oxidation of the surface thereof.

A further object of this invention is to provide a method for producing an electroless nickel plated cast iron skillet, pot, pan, or other cookware.

Another object of the invention is to provide a nickel plated item of cookware, which is resistant to food sticking to the surface thereof, and which retains its lubricity for its entire lifetime of use.

Another object of the invention is to provide a tough, durable, long lasting, item of cookwear, which is resistant to corrosion.

Another object of the invention is to provide cookware which does not retain any indication of an item previously cooked therein.

### BRIEF DESCRIPTION OF THE DRAWINGS

The foregoing and other objects will become more readily apparent by referring to the following detailed description and the appended drawing in which:

FIG. 1 is a diagram of the method of electroless nickel plating of cookware according to the invention.

FIG. 2 is a cross-sectional diagram of an electroless nickel plating tank with an immersion rack.

FIG. 3 is a cross-sectional diagram of an alternative embodiment of an electroless nickel plating tank and associated immersion apparatus.

### DETAILED DESCRIPTION

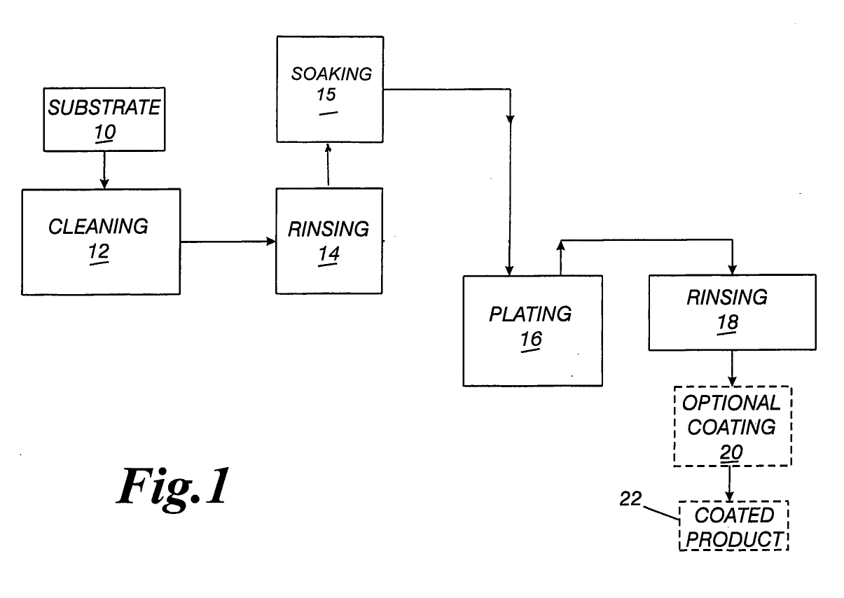

Referring now to the invented method as illustrated in FIG. 1, a cast iron metal cookware substrate 10 is provided, which undergoes a cleaning step 12, followed by a rinsing step 14. The substrate is moved to and undergoes a plating step 16, which is followed by another rinsing step 18. An optional coating step 20 may be used to apply a stain resistant coating to the surface of the cookware. The product of the method depicted is an item of coated nickel cookware 22.

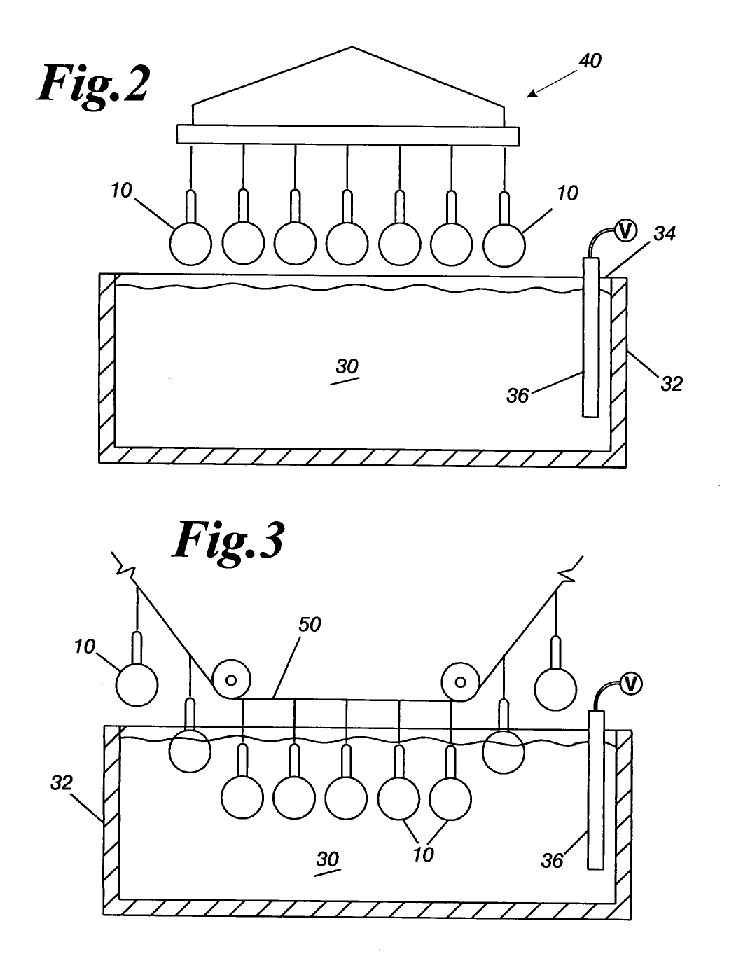

A nickel plating bath is shown in FIG. 2, into which an electroless plating solution 30 is supplied in sufficient quantity to fill a plating tank 32 to within a few inches of the top 34 of the tank, and is heated by any suitable means, such as an immersion heater 36, a heating jacket surrounding the tank, or an induction heater. If the immersion heater is electric, as shown, it is connected to a source of electricity V.

Prior to plating, the surface to be plated or coated is selectively cleaned and prepared to accept the nickel coating in step 12. This step includes one or more of grinding, cleaning, polishing, blasting, and etching procedures. Preferably, the cast iron pan or other cookware item is cleaned with a blast of glass beads, at a high pressure, usually about 70 psi.

After cleaning, the substrate is rinsed. Air is blown against the substrate to remove particulate material remaining thereon, followed by a blast of clean, filtered water to clean off the remaining residue.

The cast iron substrate is then soaked in a dilute potassium carbonate (K₂CO₃) bath 15 for a period of not less than 3 minutes. The bath solution is about 4 ounces of potassium carbonate per 20 gallons of water. This bath purges the pores of the cast iron. This allows the cast iron to be plated to Mil. Spec. C-26074E, and to ASTM B117, which it is believed has not been accomplished prior to this invention.

The cookware substrate is inserted into the plating bath, without rinsing, for a period of time sufficient to attain a plating thickness of not less than 0.0025 inch, during which air sparging of the bath is conducted to cause circulation of the bath and complete coverage of the substrate by the nickel containing coating. The plating can be any desired thickness, but usually is less than 0.0100 inch. For a plating thickness in the optimum range, the substrate should remain in contact with the plating material for about 1½ to 2 hours. The temperature of the plating bath is advantageously in the range of from 180 to 202 F, and preferably in the range of 192 to 196 F. The preferred pH of the bath is 4.7 to 5.0.

The cookware substrates 10 may be suspended from a rack 40 into the plating solution 30 as shown in FIG. 2, or they may be attached to a moving wire 50, as shown in FIG. 3, which dips downward to place the substrates into the plating solution, removing the substrates after they have been in the plating bath for a sufficient period of time. Immersion of the cookware substrates into the plating solution may be accomplished by any other convenient means.

The electroless nickel layer may be applied in a single bath or a series of baths, with the electroless nickel being in a solution of nickel sulfate (NiSO₄) and hypophosphite. The conventional method of identifying electroless nickel is by the phosphorus content, (e.g., low phosphorus 2-5%; medium phosphorus 6-9%; and high phosphorus 10-14%), the balance being nickel. The phosphorus content of the electroless nickel layer in the present invention is no greater than the upper limit of high phosphorous content of 14%, and preferably the phosphorus content is in the high range, but more preferably the weight percent of phosphorous is about 12 to about 14 weight percent of the coating as deposited on the substrate with the remainder nickel. The preferred coating is about 88% nickel and about 12% phosphorus. Although the plating bath contains other chemicals in addition to phosphorus and nickel, which aid in the plating process, these other chemicals are not deposited on the substrate.

The plated cookware is rinsed with clean water at least once, preferably twice, to remove excess nickel. The plated cookware is then placed in filtered water at a temperature in excess of 110° F., preferably about 125° F., to raise the temperature of the cookware. This is followed by blowing with air, which causes the water to evaporate rapidly because of the high temperature of the cookware.

Optionally, a stain resistant coating, such as vegetable oil, may be applied to the surface of the substrate in optional coating step 20.

The nickel in the plating solution is an FDA approved lead-free, cadmium-free solution, formulated and blended to contain no less than 86% nickel and no more than 14% phosphorus.

Lead is usually added to a plating solution as a stabilizer, while cadmium is normally added as a brightener. The invented process employs neither lead nor cadmium, which results in a coating which is free of both lead and cadmium. The plating solution contains principally nickel and phosphorous.

The nickel from the plating solution is applied to the substrate surface at a thickness no less than 0.0025 inch and normally no more than 0.0100 inch.

The nickel is applied uniformly over the entire surface, sealing the cast iron substrate from the atmosphere, insuring total coverage and adhesion.

The nickel plating, will pass an ASTM (American Society of Testing Materials) nitric acid test and an ASTM B 117 1000-hour salt spray test, and will achieve a minimum hardness of 58 on the Rockwell C scale. The nickel coating will meet military specification standard Mil-C-26074E, which is a corrosion resistance specification.

The nickel plating solution is an aqueous solution which can include a composite of phosphorus, boron, diamond, silicon, nitrate, or any such desired bath or composite.

The composition of the electroless nickel-plating bath may be any suitable composition which will result in the desired coating, for example, any of the compositions set forth in Table 1, Page 741, Vol. 8 of “Encyclopedia of Chemical Technology”, Third Edition, Dan Wiley & Sons, N.Y., 1979, which are also set forth in abstract format in the Table in U.S. Pat. Nos. 2,532,283 and 2,999,770. A nickel-phosphorus coating has an amorphic structure with a natural lubricity.

The method of making an item of coated cast iron cookware basically comprises the steps of: a) providing a substrate consisting or a pot, pan or other cookware to be coated; b) cleaning or deoxidizing the surface of the substrate to be coated; c) soaking the substrate in a dilute potassium carbonate bath; and d) applying an electroless nickel coating to the surface of the cast iron substrate.

### SUMMARY OF THE ACHIEVEMENT OF THE OBJECTS OF THE INVENTION

From the foregoing, it is readily apparent that I have invented an improved non-stick coated cast iron skillet, pot, pan, or other cookware, which is durable and resistant to corrosion, which has a coating that inhibits oxidation of the surface thereof, which does not retain any indication of an item previously cooked therein, and which is resistant to food sticking to the surface thereof, as well as providing a method for producing an electroless nickel coated cast iron skillet, pot, pan, or other cookware.

It is to be understood that the foregoing description and specific embodiments are merely illustrative of the best mode of the invention and the principles thereof, and that various modifications and additions may be made to the apparatus and method by those skilled in the art, without departing from the spirit and scope of this invention, which is therefore understood to be limited only by the scope of the appended claims.

What is claimed is:

1. A coated metal cookware article, comprising:
a cast iron substrate; and
an electroless nickel plated coating thereon, said coating being not less than 0.0025 inch in thickness.

2. A coated metal cookware article according to claim 1, whereon said coating has a thickness no greater than 0.0100 inch.

3. A coated metal cookware article according to claim 1, whereon said coating has a nickel content no less than about 86 percent.

4. A coated metal cookware article according to claim 1, whereon said coating has a phosphorus content of about 12 to 14%.

5. A coated metal cookware article according to claim 1, whereon said coating is free of cadmium and lead.

6. A coated metal cookware article according to claim 1 wherein said coating is about 88% nickel and about 12% phosphorous.

7. A coated metal cookware article according to claim 1, wherein said substrate is selected from the group consisting of a pot, pan, skillet, griddle, grill, or cooking grate.

8. A method of making an item of nickel-plated cast iron cookware, comprising the steps of:
a) providing a cast iron cookware substrate consisting of a pot, pan, skillet, griddle, grill, or cooking grate to be coated;
b) cleaning or deoxidizing the surface of the substrate to be coated;
c) soaking the substrate in a dilute potassium carbonate solution for a period of at least 3 minutes; and
c) applying an electroless nickel coating to the surface of the substrate at a temperature of from 180 to 202 F for a sufficient period of time to form a nickel plating of no less than 0.0025 inch.

9. A method according to claim 8, wherein the step of applying the electroless nickel coating is carried out in a bath solution consisting essentially of nickel sulfate (NiSO₄) and hypophosphite.

10. A method according to claim 9, wherein the temperature of the plating bath is in the range of from 180 to 202 F.

11. A method according to claim 10, wherein the temperature of the plating bath is in the range of from 192 to 196 F.

12. A method according to claim 9, wherein the pH of the plating bath is in the range of from 4.7 to 5.0.

13. A method according to claim 9, wherein the cleaning step comprises one or more of the steps of grinding, cleaning, polishing, blasting, and etching the surface of the substrate to be coated.

14. A method according to claim 13 wherein the cleaning step comprises blasting of the substrate with glass beads.

15. A method according to claim 8, wherein the potassium carbonate solution consists of about 4 ounces potassium carbonate to 20 gallons of water.
